(19) United States
(12) Patent Application Publication
(10) Pub. No.: US 2016/0212076 A1
(43) Pub. Date: Jul. 21, 2016

(54) System, Method, and Apparatus for Providing Prayers over a Network

(71) Applicant: Pray Forward, LLC

(72) Inventors: Joseph S. Bellissimo, Ellwood City, PA (US); John Swisher, Ellwood City, PA (US)

(21) Appl. No.: 14/855,948

(22) Filed: Sep. 16, 2015

Related U.S. Application Data
(60) Provisional application No. 62/051,055, filed on Sep. 16, 2014.

(51) Int. Cl. H04L 12/58; G06F 17/30; G06F 17/21

(52) U.S. Cl. CPC H04L 51/10; G06F 17/212; G06F 17/30528; G06F 17/30525; G06F 17/30554

(57) ABSTRACT

Provided is a computer-implemented method, system, and apparatus for displaying at least one prayer on at least one client device including at least one processor. The method includes receiving, at least one server computer, a share request from a first client device, the share request comprising: a selection of at least one prayer, and at least one customization option for the at least one prayer; generating, with at least one processor, the customized prayer based at least partially on the share request; and communicating the customized prayer to at least one second client device.

### CROSS-REFERENCE TO RELATED APPLICATIONS

This application claims priority to U.S. Provisional Patent Application No. 62/051,055, filed Sep. 16, 2014, the disclosure of which is hereby incorporated in its entirety by reference.

### BACKGROUND OF THE INVENTION

1. Field of the Invention

This invention relates generally to a system for providing prayers over a network and, more specifically, a system, method, and apparatus for providing customized prayers on a device.

2. Description of Related Art

Religious and/or philosophical sentiment is an important part of human society, and many people feel called to share their religious and/or philosophical sentimentalities with others. There are many well-established prayers and/or philosophical statements that have a wide appeal, which have become important to the lives of people of many different cultures. Some of these prayers and/or philosophical statements have been in existence for hundreds, or even thousands, of years.

However, it is recognized that religious and/or philosophical sentimentalities are highly personal, in that there is a great variation among cultures, families, and individuals about how best to share one's beliefs, and show a devotion to a higher power, even when portions of such well-established prayers and/or philosophical statements are to be used. Further, new prayers, philosophies, and methods of worship are created every day, and many people desire to create and share new prayers and/or philosophical statements with others.

### SUMMARY OF THE INVENTION

Accordingly, there is a need in the art for a system, method, and apparatus that allows a user to search for, customize, and/or share prayers and/or philosophical statements with other users, such as remote users communicating over a network. In order to address the aforementioned issues, a computer-implemented method, system, and apparatus are provided for sharing and/or displaying at least one prayer and/or philosophical statement within and/or over a network environment.

According to a non-limiting embodiment, a computer-implemented method is provided for displaying at least one prayer on at least one client device including at least one processor. The method includes: receiving, the at least one server computer, a share request from a first client device, the share request including: a selection of at least one prayer, and at least one customization option for the at least one prayer. The method may further include generating, with the at least one processor, a customized prayer based at least partially on the share request, and communicating the customized prayer to at least one second client device. The customized prayer may be generated at least partially based on the share request.

The at least one customization option may include at least one of the following: a font color, a font style, a background color, a selection of a pre-recorded or computer-generated voice in which the prayer is to be verbalized on the at least one second client device, a language of the prayer, an addition, deletion, or replacement of a portion of the text of the prayer, a specific translation of the prayer, and a selection of a version of the prayer associated with a particular religious denomination, or any combination thereof.

The at least one prayer may be selected from a prayer database including a plurality of prayers indexed by at least one of the following: religious denomination, keyword, appropriate occasion, popularity, average user rating, and appropriate recipient, or any combination thereof. Further, the plurality of prayers may be displayed in a result set including at least one of the following: shortened versions, shortened titles, and abbreviations of the prayers, or any combination thereof.

Additionally, the at least one prayer may include a user-generated prayer, and the method may further include receiving the user-generated prayer at the at least one server computer and indexing the user-generated prayer in a prayer database in communication with the at least one second client device. The user-generated prayer may be indexed by at least one of the following: religious denomination, keyword, appropriate occasion, popularity, average user rating, appropriate recipient, or any combination thereof.

The share request may further include at least one supplemental dispatch, the supplemental dispatch including at least one of: a textual message, an image, a photograph, a virtual icon, an audio message, a video message, an indication of the geographic location of the first client device, a request to have a gift sent to a recipient, a monetary gift to a recipient, a virtual gift to a recipient, or any combination thereof. The method may further include communicating data corresponding to the at least one supplemental dispatch to the at least one second client device.

The method may further include providing the first client device with an electronic version of at least a portion of at least one religious text, and the at least one prayer may include a selection from the at least one religious text.

Further, the customized prayer may be communicated through the internet via at least one of the following media: email, text message, a social media service, a mobile application, or any combination thereof.

Additionally, the method may further include identifying at least one temporal event, and at a specified time associated with at least one temporal event, causing the first client device to display an audio or visual notification that a prayer should be sent. The at least one temporal event may be identified based at least partially on at least one of the following: data from an electronic calendar in communication with the first client device, data inputted by a user or administrator into the at least one client device or a management computer, or any combination thereof.

A user of at least the first client device may be required to establish an account with a host in order to place a share request. The method may further include selectively enabling a user associated with the first client device to utilize only a portion of a selection of available customization options, as determined at least partially based on at least one access parameter associated with the user's account.

The at least one access parameter may include at least one of the following: an amount of payment that has been rendered by the user for additional functionality, a number of categories from which the user has shared prayers, a number of unique prayers the user has shared in a specified time period, a number of total prayers the user has shared in a specified time period, an amount of time a user has been using a specified mobile application, or any combination thereof.

According to another non-limiting aspect of the present invention, a system is provided for displaying at least one prayer on at least one client device including at least one processor. The system may include at least one server computer programmed or configured to receive a share request from at least a first client device, generate a customized prayer based at least partially on the share request, and communicate the customized prayer to at least one second client device, the share request including: a selection of at least one prayer and at least one customization option for the at least one prayer.

The at least one customization option may include at least one of the following: a font color, a font style, a background color, a selection of a pre-recorded or computer-generated voice in which the prayer is to be verbalized on the at least one second client device, a language of the prayer, an addition, deletion, or replacement of a portion of the text of the prayer, a specific translation of the prayer, a selection of a version of the prayer associated with a particular religious denomination, or any combination thereof.

The at least one prayer may be selected from a prayer database including a plurality of prayers indexed by at least one of the following: religious denomination, keyword, appropriate occasion, popularity, average user rating, and appropriate recipient, and the plurality of prayers may be displayed in a result set including shortened versions, shortened titles, abbreviations of the prayers, or any combination thereof.

The at least one prayer may include a user-generated prayer, and the at least one server computer may be further programmed or configured to index the user-generated prayer in a prayer database in communication with at least one second client device. The user-generated prayer may be indexed by at least one of the following: religious denomination, keyword, appropriate occasion, popularity, average user rating, appropriate recipient, or any combination thereof, and indexed either automatically or based at least partially on data provided by at least one user or administrator.

The share request may further include at least one supplemental dispatch, the supplemental dispatch including at least one of the following: a textual message, an image, a photograph, a virtual icon, an audio message, a video message, an indication of the geographic location of the first client device, a request to have a gift sent to a recipient, a monetary gift to a recipient, a virtual gift to a recipient, or any combination thereof. The at least one server computer may be further configured or programmed to communicate data corresponding to the at least one supplemental dispatch to the at least one second client device.

The first client device may be provided with an electronic version of at least a portion of at least one religious text and the at least one prayer may include a selection from the at least one religious text. The customized prayer may be communicated through the internet via one of the following media: email, text message, a social media service, or any combination thereof.

The at least one server computer may be further programmed or configured to: identify at least one temporal event, and at a specified time associated with the at least one temporal event, cause the first client device to display an audio or visual notification that a prayer should be sent. The at least one temporal event may be identified based at least partially on: data from an electronic calendar in communication with the first client device, data inputted by a user or administrator into the at least one client device or a management computer, or any combination thereof.

A user of at least the first client device may be required to establish an account with a host in order to place a share request and the at least one server computer may be further programmed or configured to selectively enable a user associated with the first client device to utilize only a portion of a selection of available customization options, as determined at least partially based on at least one access parameter associated with the user's account.

The at least one access parameter may include: an amount of payment that has been rendered by the user for additional functionality, a number of categories from which the user has shared prayers, a number of unique prayers the user has shared in a specified time period, a number of total prayers the user has shared in a specified time period, an amount of time a user has been using a specified mobile application, or any combination thereof.

According to a further non-limiting embodiment, provided is a non-transitory machine-readable medium having program instructions that, when executed by at least one client device including at least one processor, cause the at least one device to: communicate a share request to at least one server computer, the share request including: a selection of at least one prayer, and at least one customization option for the at least one prayer, generate a customized prayer based at least partially on the share request, and cause the at least one server computer to directly or indirectly communicate the customized prayer to at least one second client device.

The at least one customization option may include at least one of the following: a font color, a font style, a background color, a selection of a pre-recorded or computer-generated voice in which the prayer is to be verbalized on the at least one second client device, a language of the prayer, an addition, deletion, or replacement of a portion of the text of the prayer, a specific translation of the prayer, and a selection of a version of the prayer associated with a particular religious denomination, or any combination thereof.

The at least one prayer may be selected from a prayer database including a plurality of prayers indexed by at least one of the following: religious denomination, keyword, appropriate occasion, popularity, average user rating, appropriate recipient, or any combination thereof. The plurality of prayers may be displayed in a result set including shortened versions, shortened titles, abbreviations of the prayers, or any combination thereof.

The at least one prayer may include a user-generated prayer, and the non-transitory machine-readable medium may further include instructions that, when executed by the at least one client device cause the device to: communicate the user-generated prayer to the at least one server computer and cause the at least one server computer to index the user-generated prayer in a prayer database in communication with at least the at least one second client device. The user-generated prayer may be indexed by at least one of the following: religious denomination, keyword, appropriate occasion, popularity, average user rating, appropriate recipient, or any combination thereof, and indexed either automatically or based at least partially on data provided by at least one user or administrator.

The share request may further include at least one supplemental dispatch, the supplemental dispatch including at least one of the following: a textual message, an image, a photograph, a virtual icon, an audio message, a video message, an indication of the geographic location of the first client device, a request to have a gift sent to a recipient, a monetary gift to a recipient, a virtual gift to a recipient, or any combination thereof. The non-transitory machine-readable medium may further include instructions that, when executed by the at least one client device, cause the at least one client device to cause the at least one server computer to communicate data corresponding to the at least one supplemental dispatch to the at least one second client device.

The first client device may be in communication with an electronic version of at least a portion of at least one religious text, and the at least one prayer may include a selection from the at least one religious text. The customized prayer may be communicated via one of the following media: email, text message, a social media service, or any combination thereof.

The non-transitory machine-readable medium may further include instructions that, when executed by the at least one client device cause the at least one client device to: identify at least one temporal event, and at a specified time associated with at least one temporal event, display an audio or visual notification that a prayer should be sent. The at least one temporal event may be identified based at least partially on: data from an electronic calendar in communication with the first client device, data inputted by a user or administrator into the at least one client device or a management computer, or any combination thereof.

A user of at least the first client device may be required to establish an account with a host in order to place a share request. The user may be selectively enabled to utilize only a portion of a selection of available customization options as determined at least partially based on at least one access parameter associated with the user's account. The at least one access parameter may include at least one of the following: an amount of payment that has been rendered by the user for additional functionality, a number of categories from which the user has shared prayers, a number of unique prayers the user has shared in a specified time period, a number of total prayers the user has shared in a specified time period, an amount of time a user has been using a specified mobile application, or any combination thereof.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of one embodiment of a customized prayer sharing system according to the principles of the present invention;

FIG. 2 is another schematic view of one embodiment of a customized prayer sharing system according to the principles of the present invention;

FIG. 3A is a flow chart showing different views of a login and registration interface according to the principles of the present invention;

FIG. 3B-D are views of the About, Terms of Service, and Privacy Policy interfaces, respectively, according to the principles of the present invention;

FIG. 4 is view of a main menu interface according to the principles of the present invention;

FIG. 5A is a flow chart showing a prayer search and selection thread according to the principles of the present invention;

FIGS. 5B-C are views of interfaces from the flow chart of FIG. 5A;

FIG. 6 is a view of a saved prayer selection interface according to the principles of the present invention;

FIG. 7A is a flow chart showing a prayer customization thread according to the principles of the present invention;

FIG. 7B is a view of interfaces from the flow chart of FIG. 7A;

FIG. 8A is a flow chart showing a prayer sharing thread according to the principles of the present invention;

FIGS. 8B-E are views of interfaces from the flow chart of FIG. 8A;

FIG. 9A is a flow chart showing an upcoming events thread according to the principles of the present invention;

FIG. 9B shows interfaces for utilizing the upcoming events thread;

FIG. 9C shows interfaces for utilizing the upcoming events thread, according to the principles of the present invention;

FIG. 10 shows a menu options thread according to the principles of the present invention and a close-up view of a selectable option for rapidly accessing the menu options thread;

FIG. 11A shows a graphical interface for sharing a client-side application with other users according to the principles of the present invention;

FIG. 11B shows interfaces for a user to submit feedback to the host according to the principles of the present invention;

FIG. 12 is a diagram showing how a user can navigate between different threads, as shown in FIGS. 3A-11B; and

FIG. 13 is a view of a schematic diagram of a computer and network infrastructure according to the prior art.

### DETAILED DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used herein, the terms “communication” and “communicate” refer to the receipt or transfer of one or more signals, messages, commands, or other type of data. For one unit or component to be in communication with another unit or component means that the one unit or component is able to directly or indirectly receive data from and/or transmit data to the other unit or component. This can refer to a direct or indirect connection that may be wired and/or wireless in nature. Additionally, two units or components may be in communication with each other even though the data transmitted may be modified, processed, and/or routed between the first and second unit or component. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit. It will be appreciated that numerous other arrangements are possible.

As used herein, the terms “prayer” or “prayers” refer to one or more philosophical statements, inspirational passages, requests from or expressions to a deity/Deity, quotations from spiritual texts, and/or any other inspirational or spiritual statements, quotations, poems, prose, and/or the like.

As used herein, the term “selectable options” refers to one or more checkboxes, pull-down menus, text inputs, push buttons, radio buttons, hypertext links, and/or other interface features.

By way of example, a prayer may refer to a verse from a holy text like the Bible, such as a passage from Romans 15:13: “May the God of hope fill you with all joy and peace in believing, so that by the power of the Holy Spirit you may abound in hope.” In another non-limiting example, prayer may refer to an inspirational or spiritual statement not found in a holy text, such as: “With thoughts of peace and courage for you, we pray for the soul of your loved one.” Other non-limiting examples of prayers may be found in the disclosure of U.S. Provisional Application No. 62/051,055, which is incorporated herein by reference.

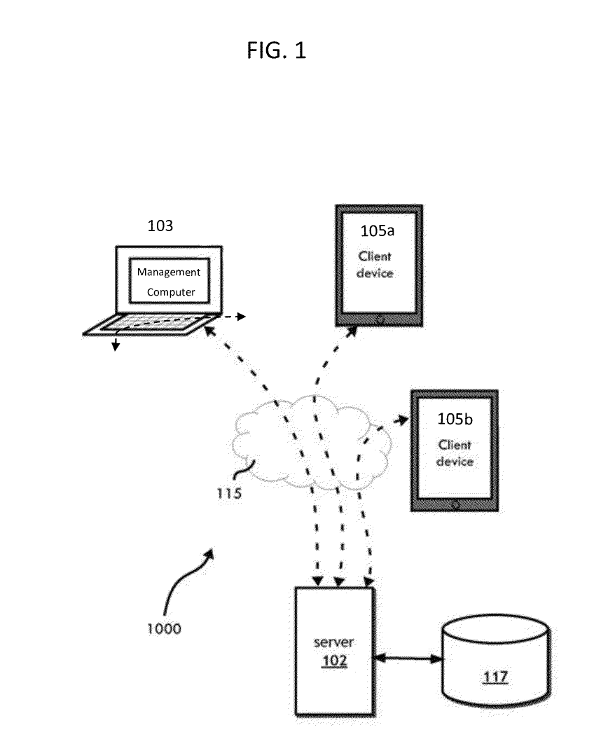

Referring to FIG. 1, a customized prayer sharing system 1000 is shown according to one preferred and non-limiting embodiment. A server computer 102 is in communication with a management computer 103 and client devices 105a, 105b through a network environment 115, such as the Internet and/or a private network. The server computer 102 is also in communication with a prayer database 117, including the text and other data related to a plurality of prayers in the database 117. In a non-limiting example, the other data may include tabulated information regarding: authorship of a prayer; the types of occasion the prayer is particularly suited to; lists of religious denominations that commonly utilize the prayer; lists of religious denominations for which the prayer is not appropriate; lists of alternate versions of the prayer including alternate translations thereof and the cultures and religious traditions with which each translation of a prayer is most commonly associated; and other like information, which can be useful to help match a prayer as appropriate to a particular intended recipient of the prayer. The management computer 103 displays a management interface based at least partially on data received from the server computer 102 and/or the prayer database 117. The management interface may be used to manage the server, expand and categorize the prayer database 117 as more information becomes available, monitor user inputs from the client devices, release software updates, or otherwise manage the system. It will be appreciated that, in non-limiting embodiments, the prayer database 117 may be edited, updated, and/or modified at least partially based on user input from the management computer 103 and/or a client device 105. Further, in some non-limiting embodiments, the prayer database 117 may be edited, updated, and/or modified automatically from one or more third-party sources. For example, data may be extracted from third-party databases using an Application Programming Interface (API) for such sources, by querying the databases, or by other methods known to those skilled in the art, at periodic intervals, continuously, or in response to new data becoming available.

With continued reference to FIG. 1, in a preferred, non-limiting embodiment, the client devices 105a, 105b may further communicate with each other via a wired connection or a wireless connection, such as near field communication or Bluetooth in order to utilize aspects of the present method and system, particularly when at least one of the client devices may not have access to the network environment 115.

The term “management computer,” as used herein, refers to any computing device capable of accessing the server computer 102 and/or the prayer database 117. The management computer 103 may include a client device used by an individual having management access or other like credentials, as an example. In another example, the management computer 103 may be a laptop, mobile device, and/or personal computer used for accessing the prayer sharing system 1000. The management computer 103 may be in communication with the server computer 102 through any number of protocols or methods such as, but not limited to, an HTTP connection through a web browser installed on the management computer 103.

As used herein, the terms “client device” and “client devices” refer to one or more hardware and/or software components that allow for user interaction and data transmission and/or receipt. In one preferred and non-limiting embodiment, the client devices are smartphones that have processing and display capabilities, and/or software applications that can run on such devices. However, it will be appreciated that a client device may be any computing device, such as a mobile or portable computing device, or components thereof.

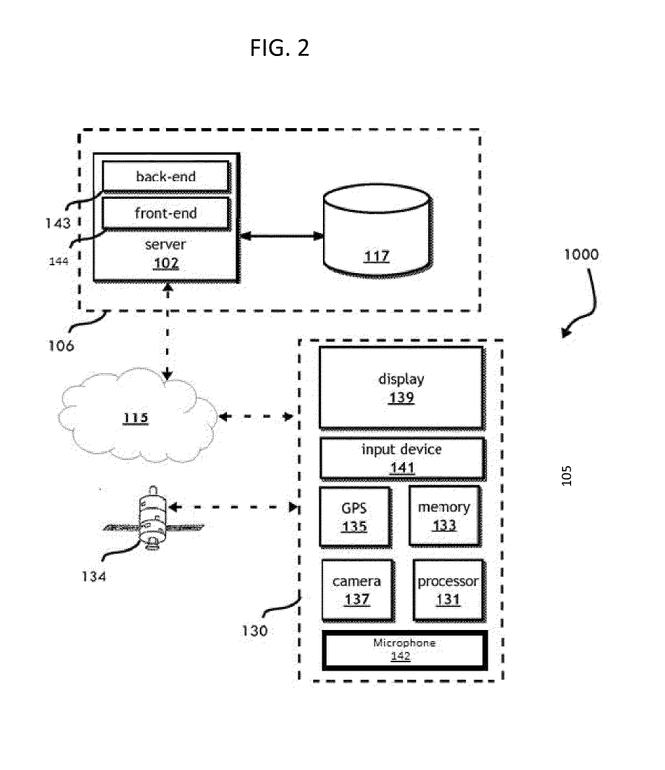

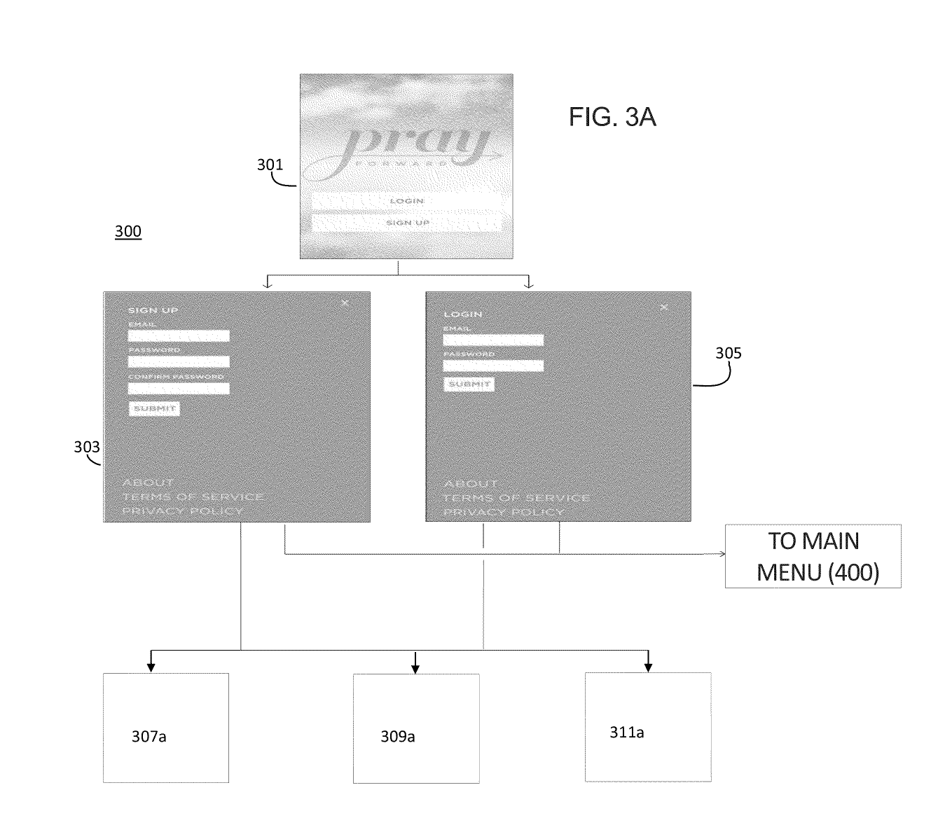

With reference to FIG. 2, the client device 105 may include, but is not limited to, an input device 141, a display device 139, a Global Positioning System (GPS) receiver 135, a processor 131, a memory device 133, a camera or optical sensing device 137, a microphone 142, network functionality, and/or the like. In one preferred and non-limiting embodiment, the client device 105 is provided with a mobile client application that may include compiled program instructions programmed or configured to perform various tasks and display various interfaces when executed. The mobile client application may also be executed by a remote computing device, such as the server computer 102, which then provides the client device 105 with display data (such as in the form of a graphical user interface (GUI), hereinafter “interface”) and receives input data from the client device 105.

With continued reference to FIG. 2, the server computer 102 may include a back-end component 143 and a front-end component 144, which respectively provide data management and data input services to the management computer 103 and the client device 105. The host 106, including the server computer 102 and prayer database 117, provides services, such as the transfer, receipt, and processing of data, to the client device 105 and the management computer 103, as well as any other devices capable of receiving and/or transmitting data. A satellite 134 may be in communication with the client device 105 to provide the client device 105 with geographic coordinates.

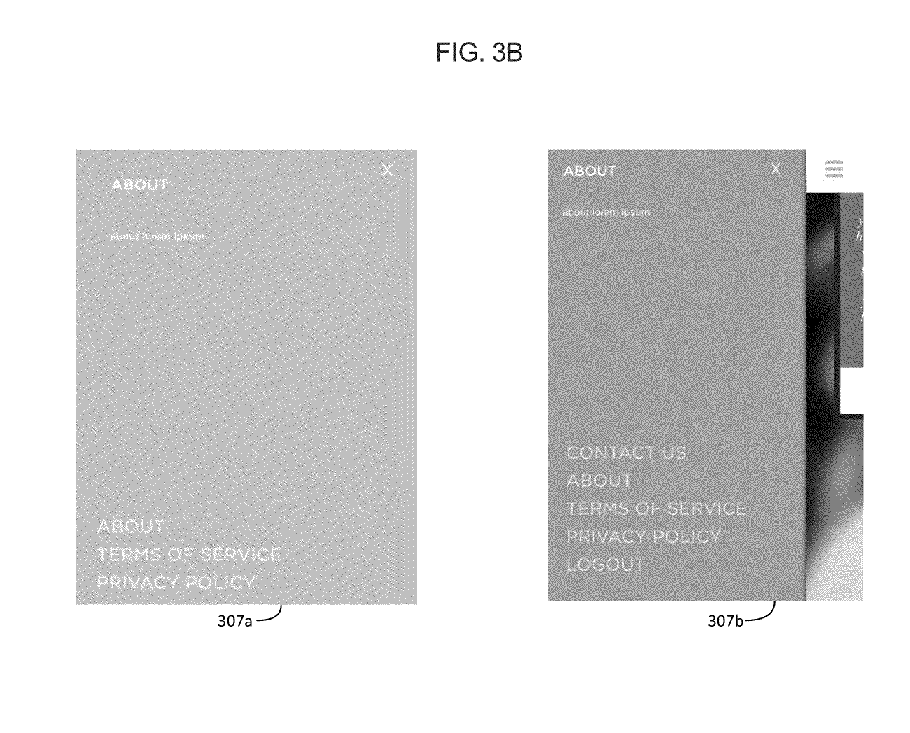

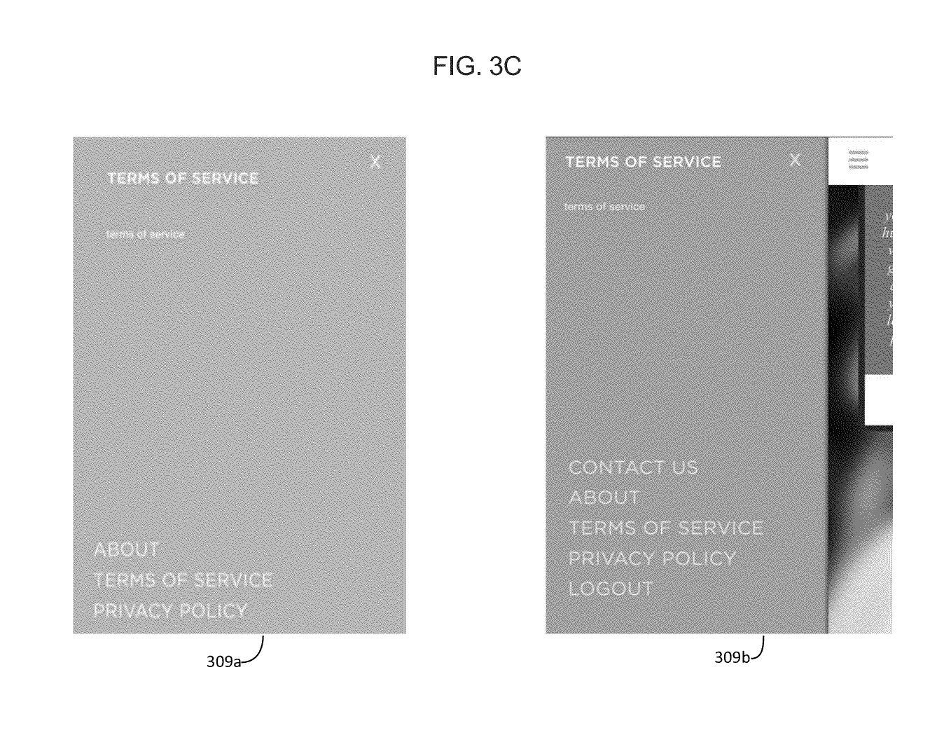

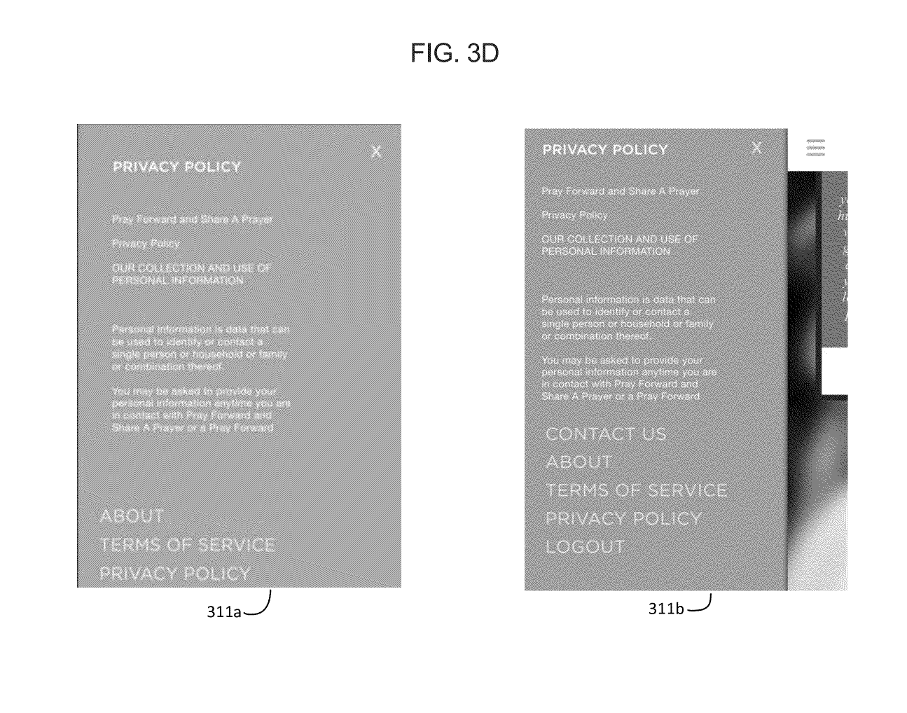

Referring to FIGS. 3A-D, different views of an interface are shown which are configured to allow a user to utilize a login thread 300 according to a preferred non-limiting embodiment. As used herein, a thread includes one or more interfaces all directed to performing a related task. By way of example, the login thread has at least one interface that allows the user to perform functions associated with logging in. When the application is started, the user is provided with login and sign-up options on a beginning menu 301. A user selecting the sign-up option is prompted to create an account using an email address and password as shown in item 303. It will be appreciated that other information may be collected such as, name, address, user name, and/or the like. In another non-limiting embodiment, the system provides the user the functionality to add logins and user profiles that are saved independent of individual devices so that preferences are available through login on multiple devices. Once an account has been created, a user may input his or her login credentials into the credential fields, shown in login interface 305. Both the sign up interface 303 and login interface 305 have selectable options for viewing an about interface 307a that provides information about the application, a terms of service interface 309a that provides information about the terms of service for using the application, and a privacy policy interface 311a that provides information about the privacy policy associated with using the application. FIGS. 3B-3D show similar about interface 307b, terms of service interface 309b, and privacy policy interface 311b are viewable by the user after logging in, and these interfaces additionally allow the user to logout or view contact information. In a preferred, non-limiting embodiment, if the user fills out either their email address or password incorrectly when logging in, he or she will be prompted to check login credentials, and the fields which are incorrect will be highlighted. In a preferred, non-limiting embodiment, if a user has forgotten his or her password, he or she can submit his or her email address and a reset link is then sent to allow the user to create a new password. When the user receives the email link, he or she will be directed back to the application where a new password can be set.

With continued reference to FIGS. 3A-D, after entering an email address and password associated with an existing account, the user's credentials may be transmitted to the server computer 102, which determines the access level of the user based at least partially on the credentials. Based on the user's access level, different interfaces may be subsequently displayed on the client device. A user's access level may be established based on various parameters including, but not limited to, whether access to certain premium features of the application that have been purchased by the user, given to the user by another user, or earned by the user via a point system which may reward the use of various features of the application, particularly in a publicized manner, and/or the provision of user feedback to the host. It will be appreciated that various other sign-up and login processes may be used.

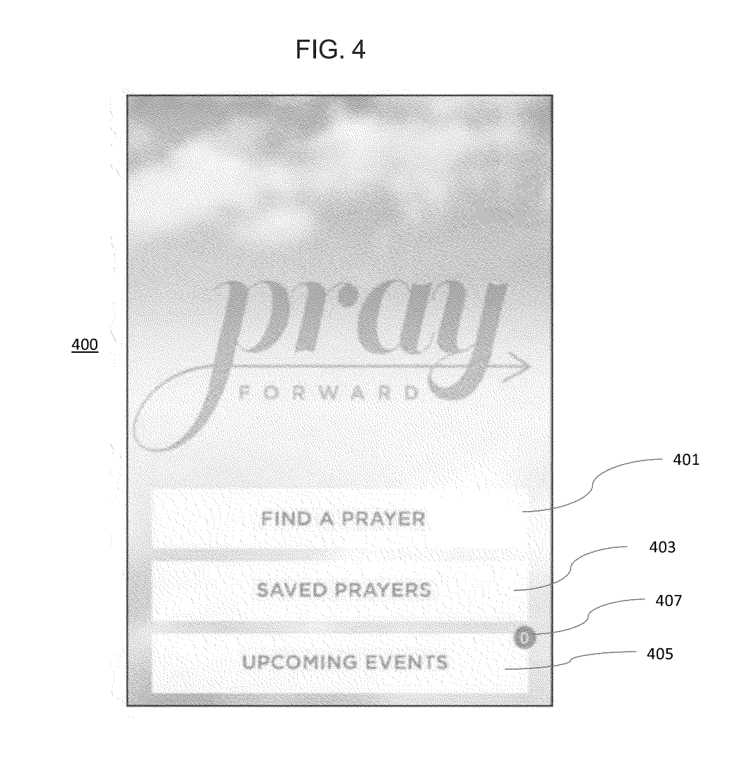

Referring to FIG. 4, after a user logs in, a main menu interface 400 is shown according to a preferred and non-limiting embodiment. The main menu interface 400 may include a find a prayer selectable option 401, a saved prayers selectable option 403, and an upcoming events selectable option 405, each of which, when pressed, causes the client device to display an interface for the corresponding thread. Further, the main menu interface 400 may include an indication as to whether one or more previously designated remotely or locally stored upcoming events is to occur in the near future in the form of a notifications icon 407. It will be appreciated that various other main menu interfaces may be used.

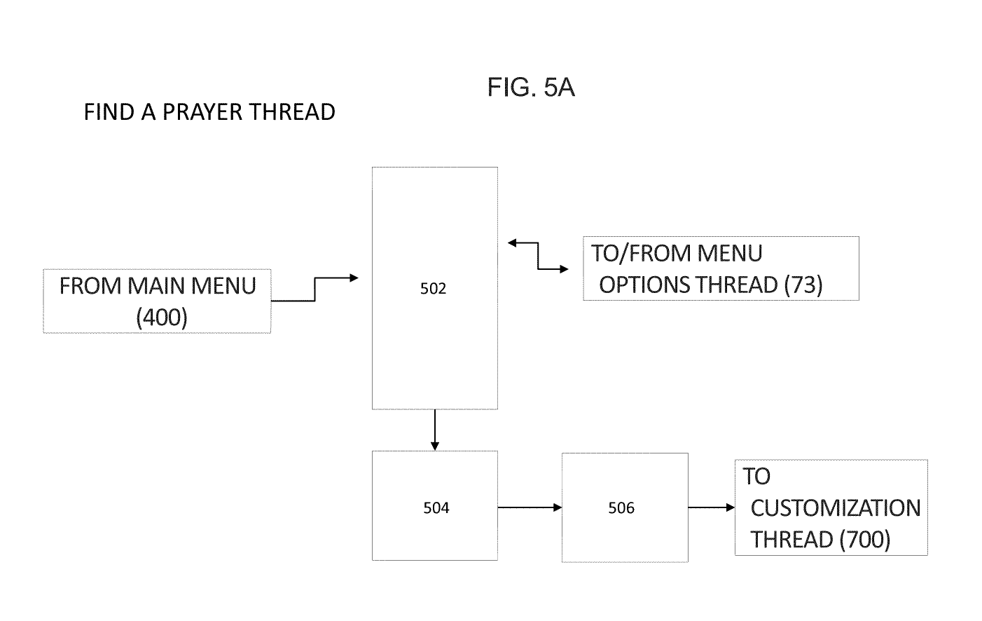

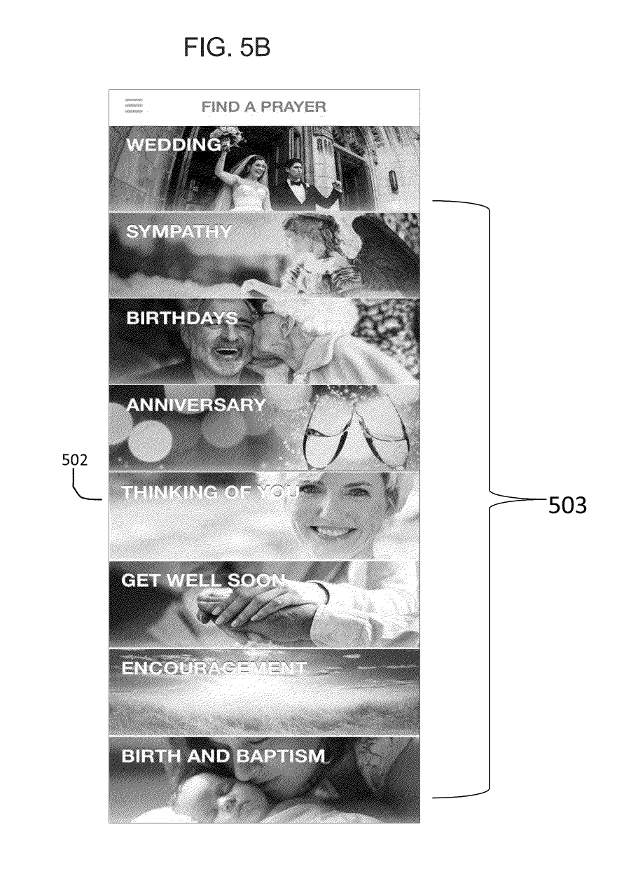

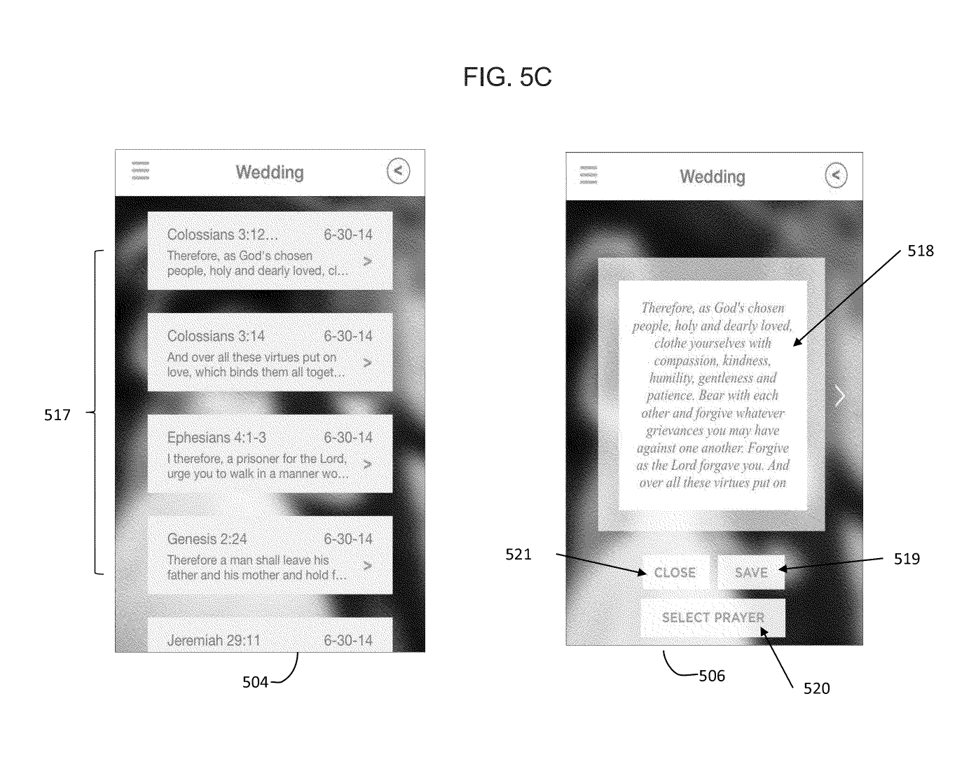

Referring to FIGS. 5A-C, FIG. 5A shows a find a prayer thread, while FIGS. 5B-5C show various interfaces included in the find a prayer thread. In the non-limiting embodiment shown, a user may enter the prayer search and selection thread from the main menu 400 or a menu options thread 73. In the prayer menu 502, a plurality of different categories of prayers are shown on selectable options 503 which the user can press to access prayers corresponding to the selected category. In another non-limiting embodiment, a keyword search bar (not shown) is provided to allow the user to search for a prayer within a category by keyword. A search bar may also be provided that allows the user to perform a keyword search from the prayers menu of all prayers and not just within a category of prayers. While searching through prayers, a user may navigate between prayers. The navigation may be performed with an arrow, scroll, or swipe functionality, as examples, to navigate between prayers while searching.

According to the non-limiting embodiment shown, the categories correspond to occasions for which the prayers are deemed most appropriate either by the host or the user (e.g., prayers for weddings, sympathy, birthdays, anniversaries, etc.). However, it will be understood that other types of categories or any combination thereof may be utilized in accordance with non-limiting embodiments of the present invention, including, but not limited to: religious denomination including all faiths and observances; keyword; popularity or critical rating (as determined by user feedback or calculated data utilizing the present system or as determined independently); appropriate type of recipient (such as persons of a specific familial relationship to the sender, persons of a specific profession, persons having specific hobbies or interests, animals such as beloved pets, groups of people such as religious congregations, etc.); or any combination thereof.

Still referring to FIGS. 5A-5C, when a category 503 is selected, a plurality of prayers are displayed in a result set interface 504 including shortened versions, shortened titles, or abbreviations of the prayers on abbreviated prayer selectable options 517 that can be selected by the user. When a prayer is selected by the user, a more complete version of the prayer 518 is displayed on a selection interface 506, from which the user can choose whether to select the prayer for customization immediately 520, save the prayer for later review 519, or return to the previous menu 521, by selecting the corresponding selectable option on the interface.

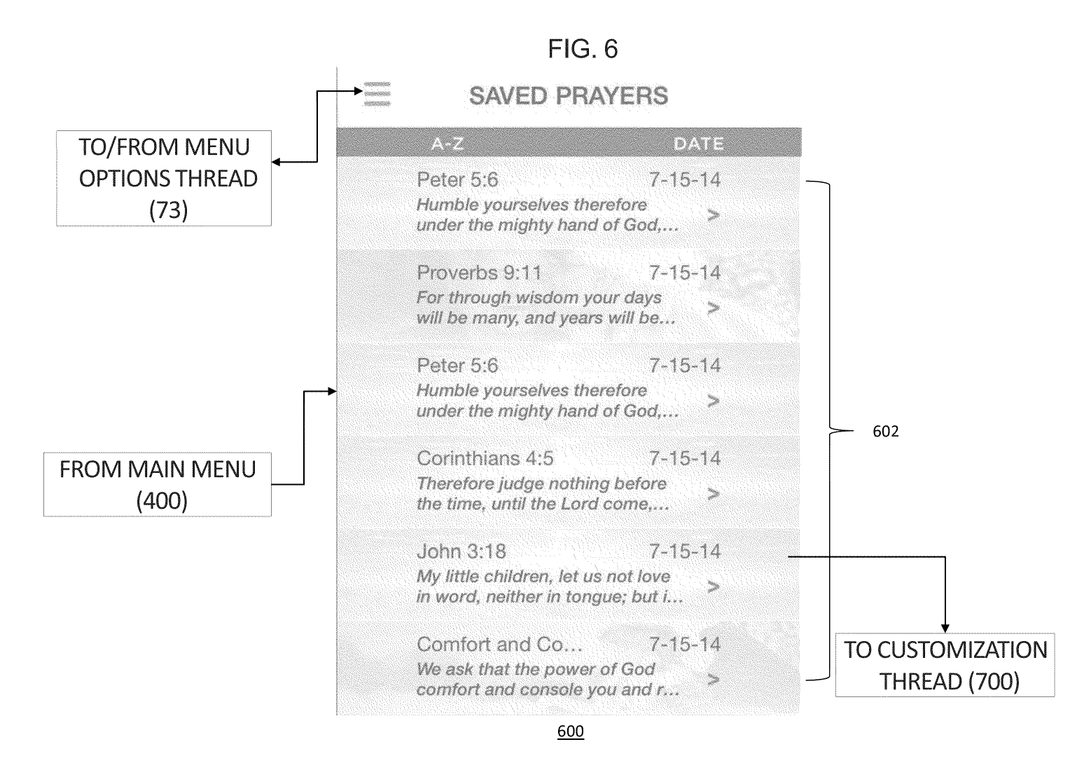

Referring now to FIG. 6, a saved prayers selection interface 600 is shown according to a preferred and non-limiting embodiment of the present invention. In the saved prayers selection interface 600, a plurality of prayers selected by the user using the prayer search and selection menu and any customizations made thereafter may be saved for later review and/or further customization. In the non-limiting embodiment shown, the prayers are listed alphabetically by title and the listings are accompanied by a date the corresponding prayer was saved or modified. However, it will be appreciated that the prayers may be categorized and/or ordered in any number of ways as previously described. In the non-limiting embodiment shown, abbreviated versions of the saved prayers are provided on a plurality of selectable options 602, which a user may press in order to display a more complete version of the prayer through the customization thread 700. Further, a user may create his or her own prayer, or customize a prayer, and assign it to various categories as described above, and save it for later review using the presently described interface. In a further preferred, non-limiting embodiment, each prayer that is sent or received using the system is automatically saved along with any customizations thereof and made available for further customization/review in the saved prayers thread. It will be appreciated that data may be saved locally to a client device and/or remotely on one or more network storage devices, databases, and/or other data storage accessible with a server.

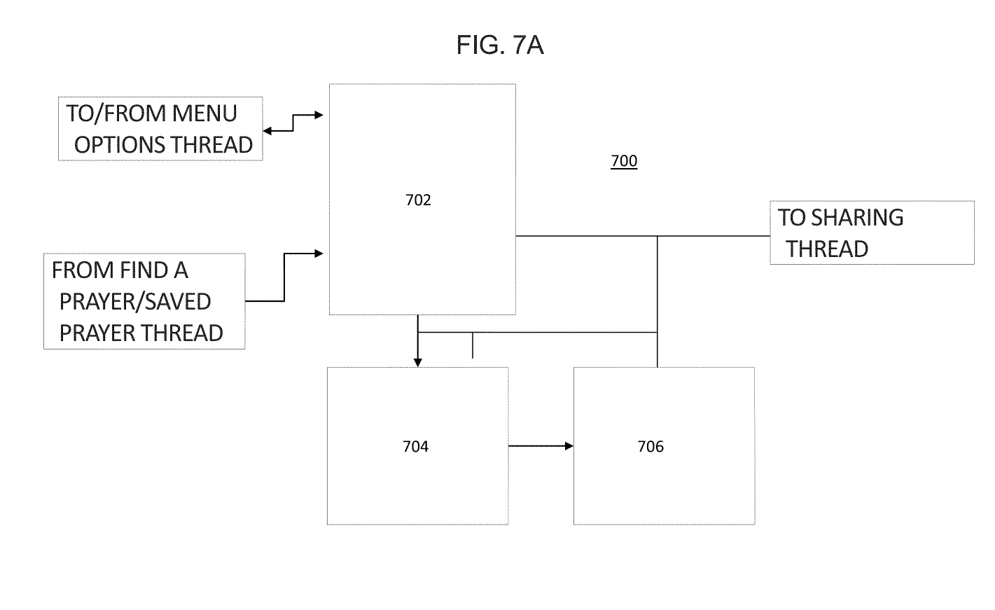

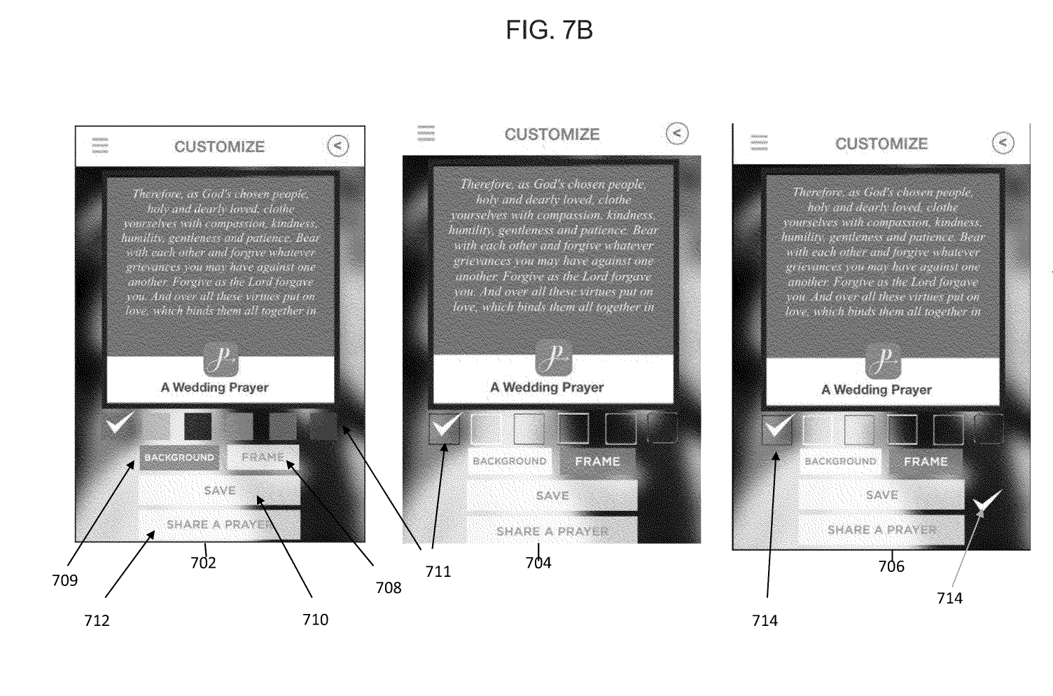

Referring now to FIGS. 7A-B, FIG. 7A shows a prayer customization thread, while FIG. 7B show interfaces included in the prayer customization thread, according to a preferred and non-limiting embodiment of the present invention. In the non-limiting embodiment shown, customization options for providing various background and frame colors are shown, along with visual indications showing what changes have been made. However, it will be appreciated that many forms of customization are contemplated including, but not limited to: a selection of a pre-recorded or computer-generated voice in which the prayer is to be verbalized on the second client device; a language of the prayer; an addition, deletion, or replacement of a portion of the text of the prayer; a specific translation of the prayer; a selection of a version of the prayer associated with a particular religious denomination; or any combination thereof.

By way of example, a user may customize the prayer by changing the language of the text of the prayer. The prayer can be translated into any language and non-limiting examples of languages into which a prayer may be translated include Spanish, French, Portuguese, Filipino, Chinese, Russian, Italian, Arabic, Polish, Hindi, and Swahili. It is also contemplated that the software application may present options in these or other languages. A user may also translate languages within the application itself. As a second customization example, a user may be able to choose from different versions of scripture to send or share. For instance, a user may pick between equivalent translated versions of the same passage, such as a passage from the King James Bible or the New American Bible. In another example, the application may enable the user to share a bible passage along with a corresponding passage from the Quran. It is also contemplated to give the user the ability to choose their own scripture verse by copying and pasting from holy texts provided within the application. Customization options may be provided to tailor to a wide variety of faiths, denominations, and observances.

According to the non-limiting embodiment shown in FIG. 7B, an initial customization interface 702 is provided which displays a full version of the prayer and displays a plurality of customization options 711 which can be accessed by pressing one of a plurality of selectable options corresponding to, in this example, modifying the background 709 and frame 708 of the prayer respectively. Further selectable options are provided for saving 710 and sharing 712 the prayer respectively. A visual indication, such as a check mark 714, may be displayed that one of a plurality of customization options 711 has been utilized and such that the presently selected prayer has been modified. It will be appreciated that other visual indications may be used. When the save prayer selectable option 710 is pressed, a notification may be displayed that the presently selected customized prayer has been saved in the saved prayers thread. Further, when the share a prayer selectable option 712 is pressed, the device displays an interface for the sharing thread 800.

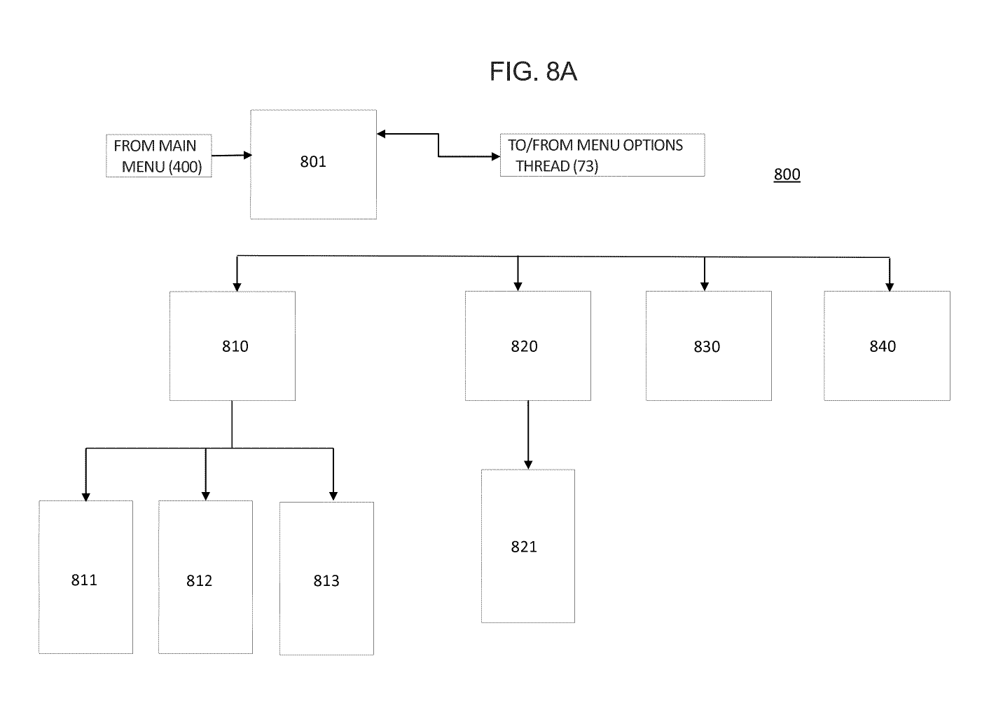

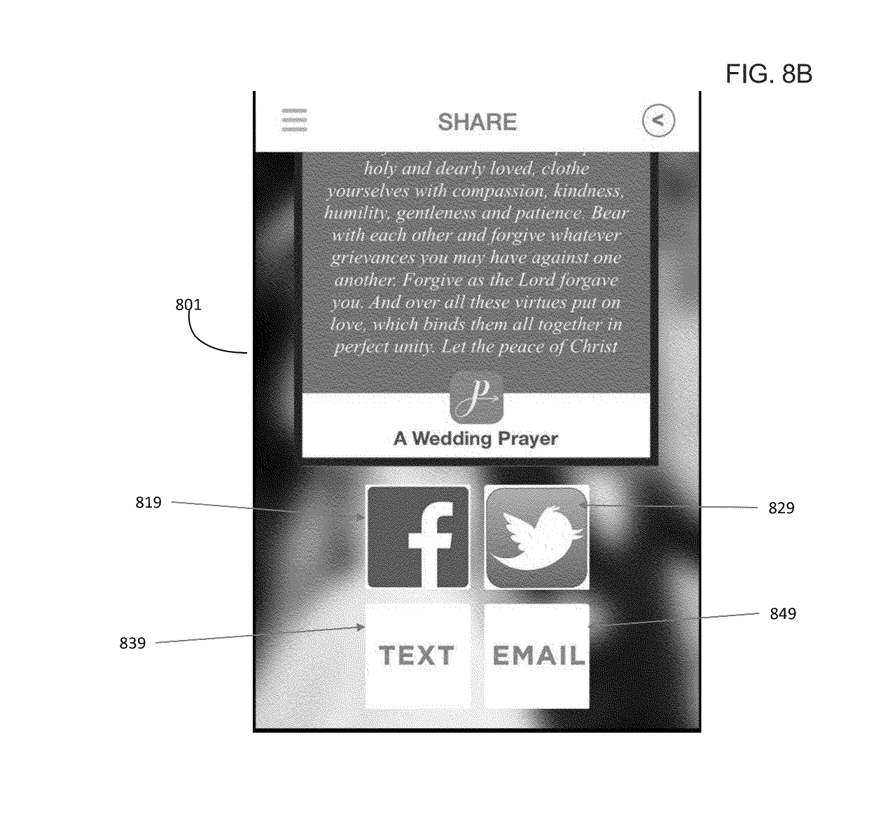

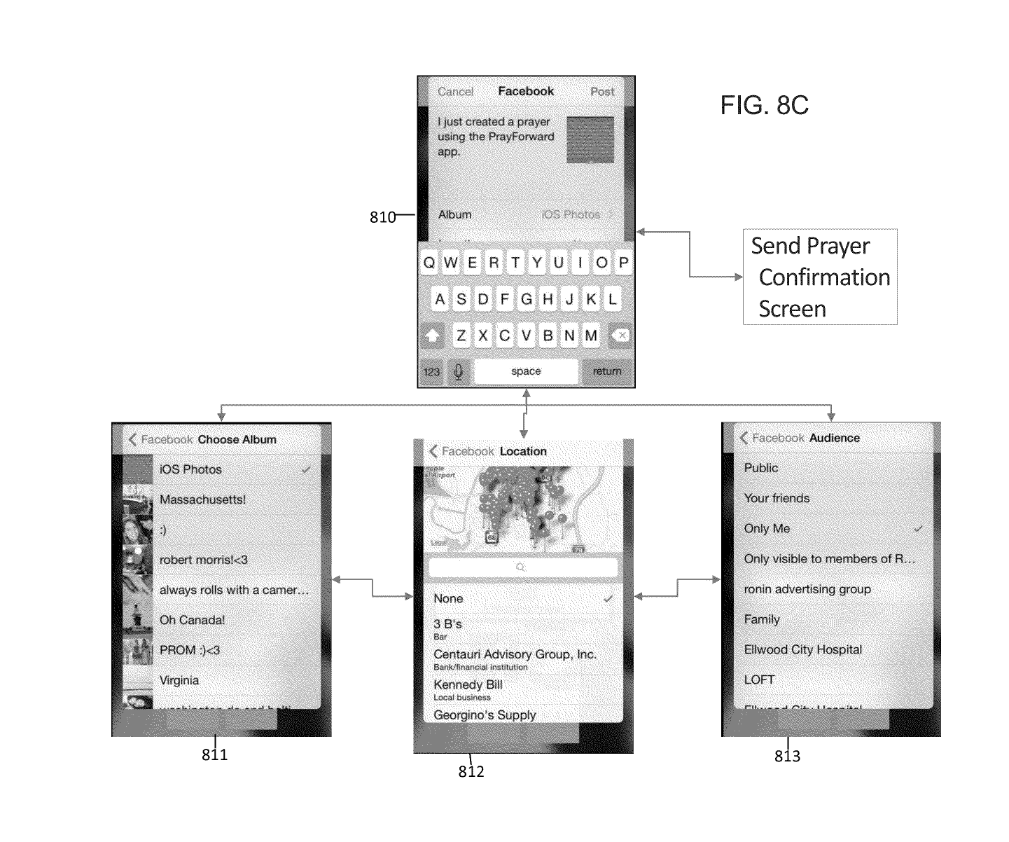

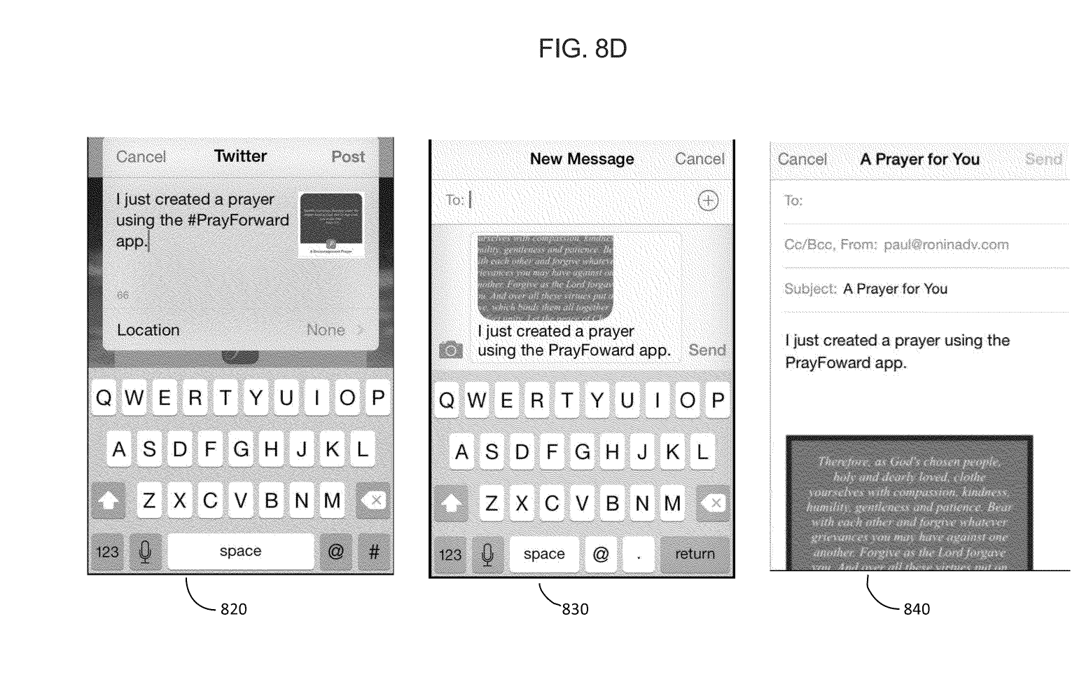

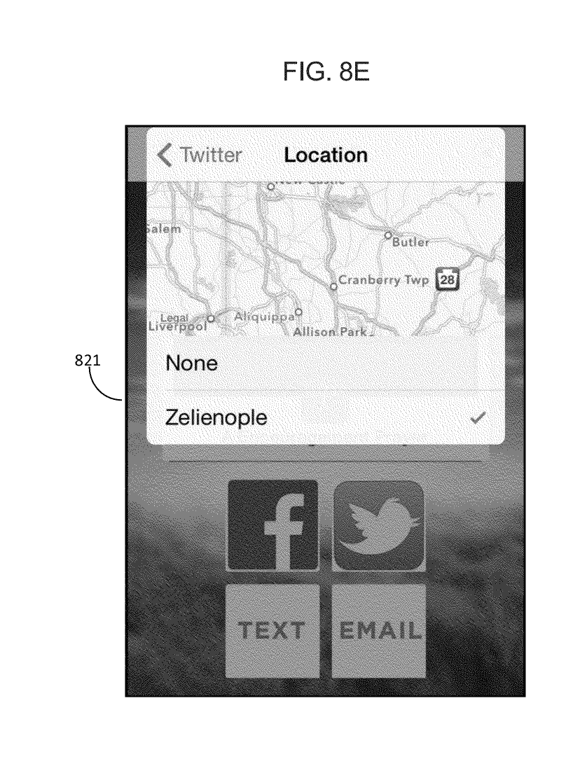

Referring now to FIGS. 8A-E, FIG. 8A shows a prayer sharing thread 800, while FIGS. 8B-E show interfaces included in the prayer sharing thread 800. All prayers shared and/or sent using any method of doing so may be added to the saved prayers menu for future viewing. In the non-limiting embodiment shown, the sharing menu interface 801 includes a plurality of online sources through which the selected prayer can be shared. The system may be configured for full social media sharing, including, but not limited to, Facebook™, Twitter™, Instagram™, etc. For instance, a user may save a customized prayer as a JPEG or other image and share that image on Instagram or other like source. Using a user's existing social media accounts to log into the system is also contemplated. By way of example, a user may log into the system using an existing Facebook™, Google+™, Instagram™, Twitter™, or other social media account. In the non-limiting embodiment shown, the share menu interface 801 includes options for Facebook™ 819, Twitter™ 829, Text 839, and Email 849, however various forms of public and private communication (as described above) are contemplated. Depending on which source is selected by the user, the user is taken to a submenu which allows the user to select additional options which are specific to the selected source.

The non-limiting embodiment shown depicts submenus for Facebook™ 810, Twitter™ 820, text 830 (e.g., SMS), and email 840 in order to illustrate some exemplary aspects of the present invention. For example, in each submenu, the user may compose a textual message to send along with the prayer, and, where supported, may also select and attach various types of files to send as well.

In both of the Twitter™ and Facebook™ geographic location submenus 812, 821, the system, user and/or client device can further select a location to display along with the prayer. It will be appreciated that other public and private communications may also allow the user and/or client device to further select a location to display along with the prayer. For example, a location may be identified by the user manually inputting a location or selecting a location using a map application, or by the system and/or client device automatically using the GPS location of the client device, cellular triangulation, proximity to and strength of wireless networks, and/or any other methods known to those skilled in the art for obtaining location. This non-limiting embodiment of the present invention may be particularly desirable for users who wish to send prayers while visiting places of religious significance, such as shrines, holy cities, cemeteries, or well-known churches, mosques, or synagogues, or if the user is in a location of personal significance to the sender or recipient.

Further, according to a non-limiting embodiment, when sharing the prayer via Facebook™ or similar social media networks, a user may select an online album in which the prayer is to be maintained in an album selection menu 811 and choose the privacy settings regarding the shared prayer in an audience menu 813.

Additionally, in accordance with a non-limiting embodiment of the present invention, a user may select and/or customize supplemental materials to send to the recipient along with the prayer, including, but not limited to, a textual message, an image, a photograph, a virtual icon, an audial and/or visual message, an indication of the geographic location of the first client device, an instruction to have a gift sent to a recipient, an electronically transmitted monetary gift to a recipient, a virtual gift to a recipient, or any combination thereof. In one embodiment, this may be accomplished using either applications internal to the system, integrating the system with outside applications, or any combination thereof. By way of example, the user may send additional items from outside vendors when sharing prayers, such as sending flowers. In this example, a user may use the application to send flowers using an outside partner vendor, such as 1-800-flowers or other florists. In this scenario, the application may have the ability to communicate with the florist to order the additional items when sharing prayers. Various APIs may be utilized to provide these features.

According to another non-limiting embodiment, the present application may also be configured to include video features. This embodiment may enable users to attach and share prayers using FaceTime or a similar application. This further includes attaching and sharing video files along with the prayer. Further, the present invention may allow users to incorporate other media features to accompany the prayers. In a non-limiting example, a user may upload or select an audio file containing hymns to send with a prayer.

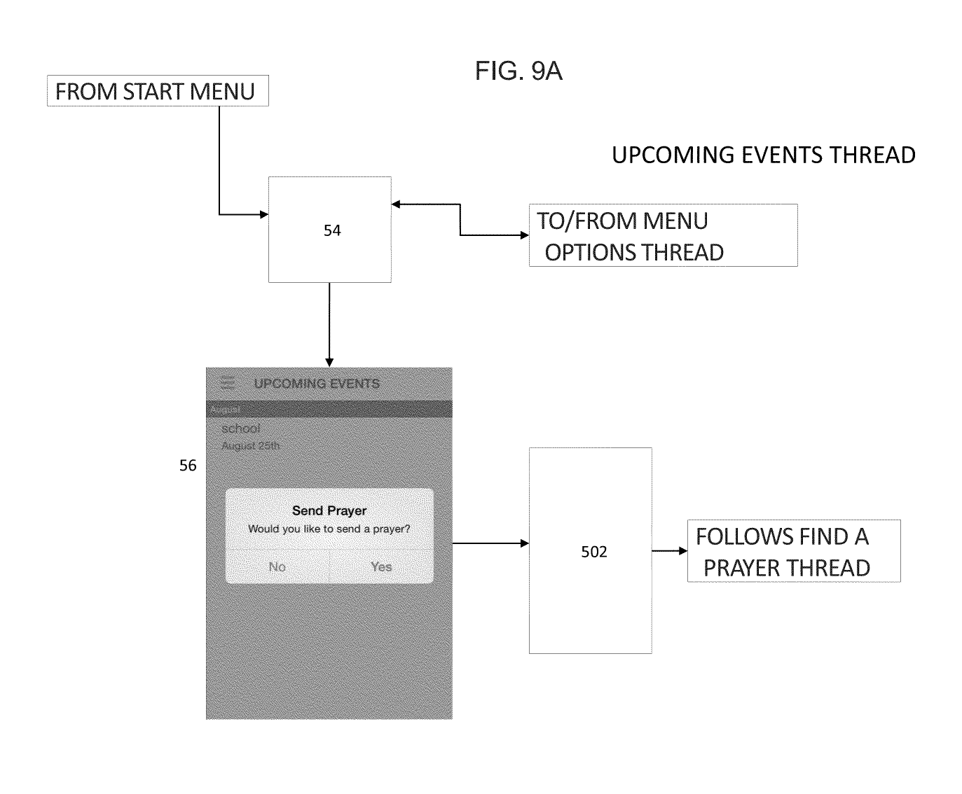

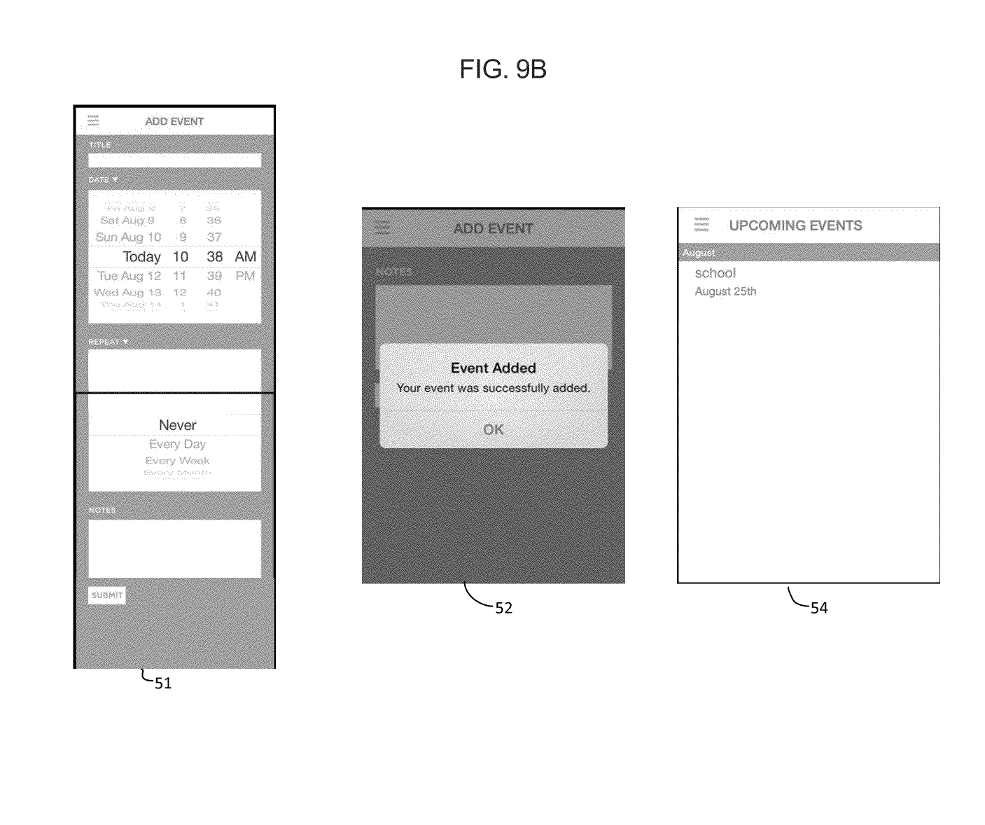

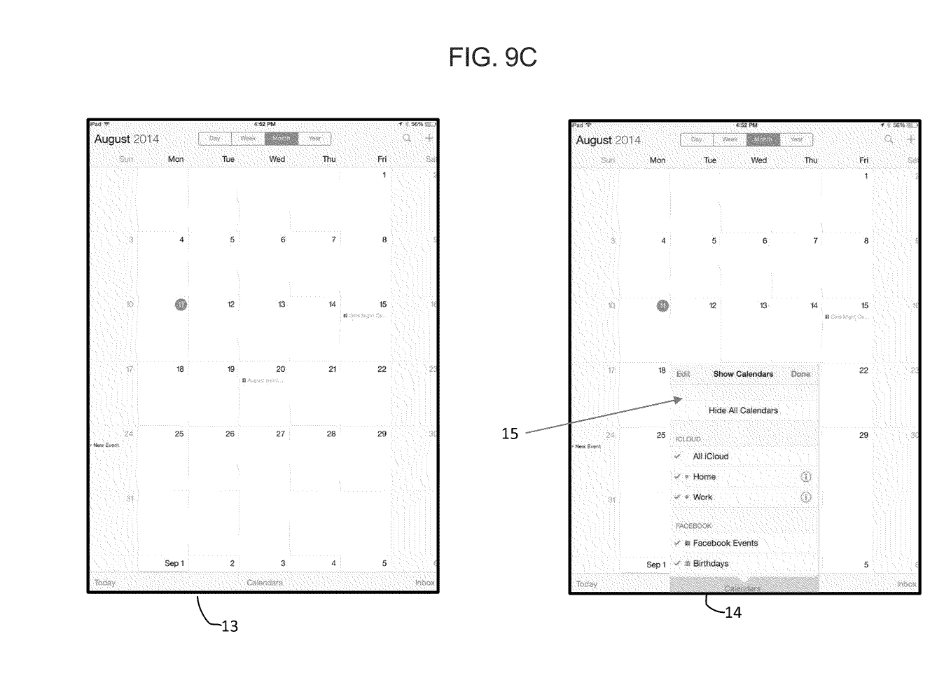

Referring now to FIGS. 9A-B, several views of an interface are shown for utilizing an upcoming events thread according to a preferred and non-limiting embodiment of the present invention. A user may create an event using a time and date selection menu 51, provide notes associated with the event, and indicate whether the event is to be recurring. A notification interface 52 is displayed when an event is successfully added. Once events are added to the application, they are displayed on an upcoming events interface 54, which allows a user to select from events that have been created on or communicated to the client device. From there, if a user selects an event, a confirmation interface 56 is displayed allowing the user to send a prayer associated with the selected event or to back out of the operation. If the user selects the send a prayer option, the prayer search and selection thread is started. In non-limiting embodiments, the user may be automatically directed to a category of prayers corresponding to the nature of the event. In further non-limiting embodiments, the system may be programmed or configured to automatically send the selected prayer to a desired recipient or group of recipients at a time and date associated with the event.

Referring now to FIG. 9C, in non-limiting embodiments, the present system may also be programmed or configured to import events from outside calendars either located on the client device or on a network in communication with the client device. Further, events may be sent to a user by other users of the system 1000. A user interface can include a calendar that is linked to an embodiment of the system 1000. The calendar 14 shown in the interface 13 has a submenu 15 opened, wherein a user can select which of a plurality of outside systems are to be utilized in the upcoming events thread in accordance with a non-limiting embodiment of the present invention. In the non-limiting embodiment shown, the system can be programmed or configured to utilize events from an iCloud™, Google Calendar™, a home email/calendar, a work email/calendar, Facebook™ events, and birthdays saved in the device, and/or other systems. However, it will be appreciated that any other like data may be imported from an external program or service.

According to another embodiment, the systems may include a fully functional calendar within the application. A separate or incorporated calendar of religious/holy days may also be included, and the system may be programmed or configured to automatically provide a user with notifications based on the occurrence of a religious/holy day. The calendar including religious/holy days may include religious/holy days from a wide variety of faiths, denominations, and observances. The application may also have the ability to direct the user towards prayers associated with a specific religious/holy day, at least in part based on information from the calendar.

In a further non-limiting embodiment, the system may enable the user the ability to add and edit added events/intentions. The system may be further enabled to provide push notifications for all events/intentions. The user may also have the ability to schedule future prayer sharing.

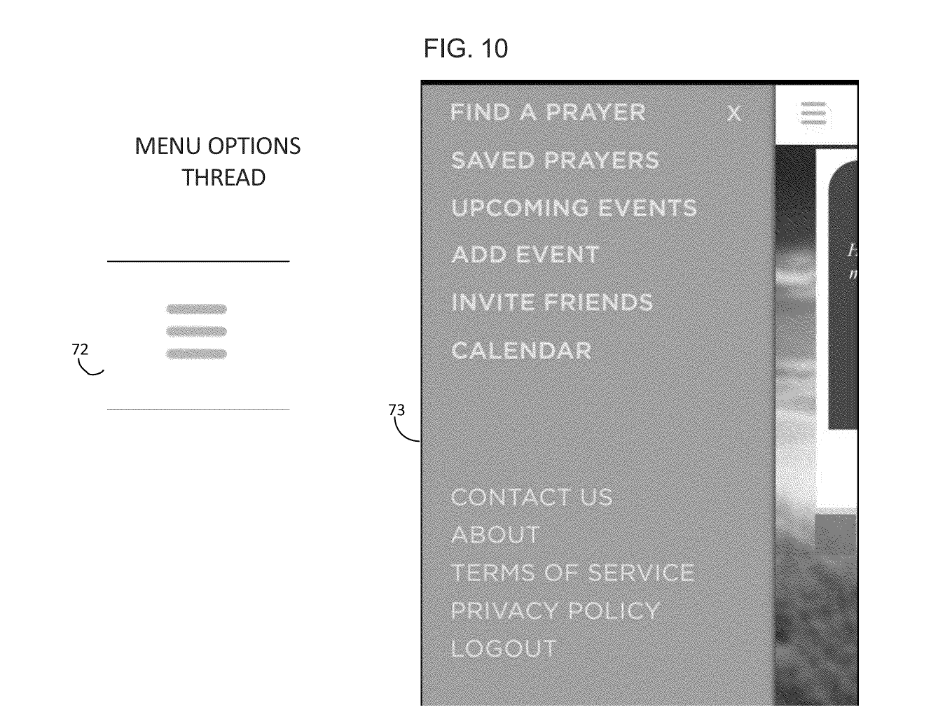

FIG. 10 shows an interface for utilizing a menu options thread 73 according to a preferred and non-limiting embodiment of the present invention. A menu selectable option 72 facilitates rapid access to the menu options thread 73. In a non-limiting embodiment, the menu options thread 73 includes several options for utilizing various aspects of the present invention, including, but not limited to: accessing a prayer search and selection thread; a saved prayers thread; an upcoming events thread; an add events menu; an interface for inviting friends to utilize the present system; an interface for providing feedback to the server operators; the about menu; the terms of service menu; the privacy policy; and an option for logging out of the application. In a non-limiting embodiment, a menu selectable option 72 is present in the interfaces for utilizing various aspects of the present invention, such that the menu can be quickly accessed from various threads.

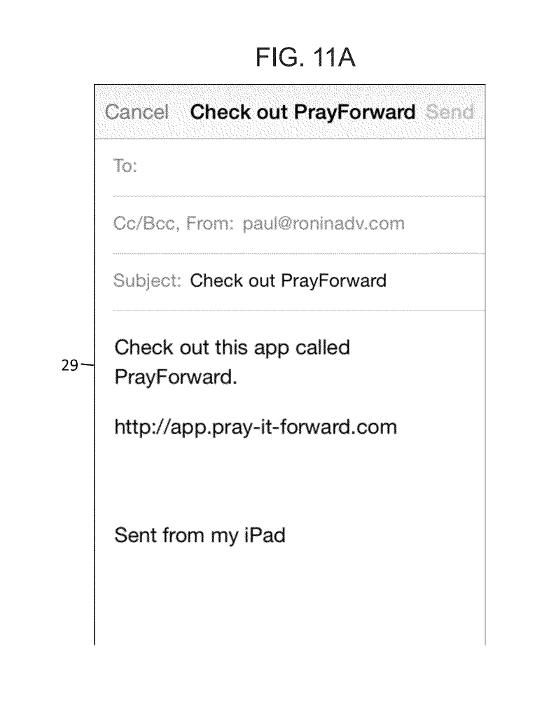

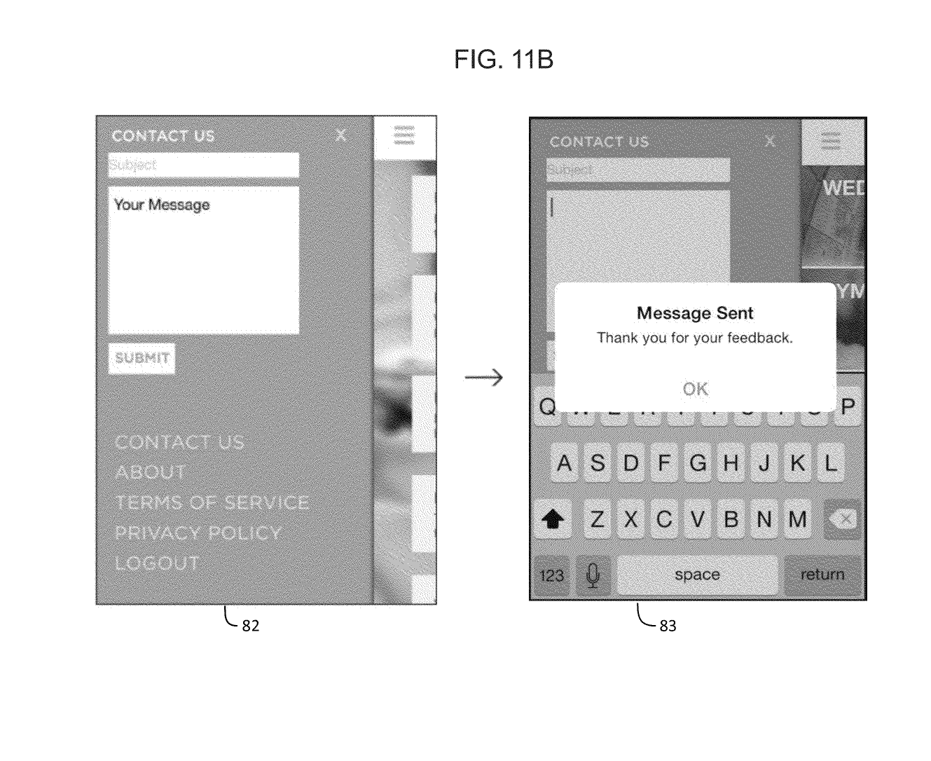

FIG. 11A shows an interface 29 for sharing a client-side application with other users according to the principles of the present invention. While the present figure illustrates sharing via email, in non-limiting embodiments, the application may be shared via any sources, services, and/or methods, including those described above.

FIG. 11B shows different views of an interface that enable a user of a client device to send feedback to a host in accordance with a non-limiting embodiment of the present invention. A user feedback interface 82 may be accessed from a contact us selectable option in the menu options thread 73 and may provide the client side user with the ability to send a message to the host. After the user enters a textual message and presses a submit selectable option 84, a “thank you” message may be displayed on a confirmation interface 83 indicating that a message has been sent. As previously described, in a preferred non-limiting embodiment, providing user feedback to the host may be rewarded by granting the user's account with greater access to the functionality of the system.

According to one non-limiting embodiment, the application allows the user to access his or her account and settings. The user can edit basic account information, such as name, email address, and password. This functionality also allows the user to deactivate their account. Before the account can be deactivated, an interface may be presented to ensure the user wants to commit to deleting all of their information and conversations.

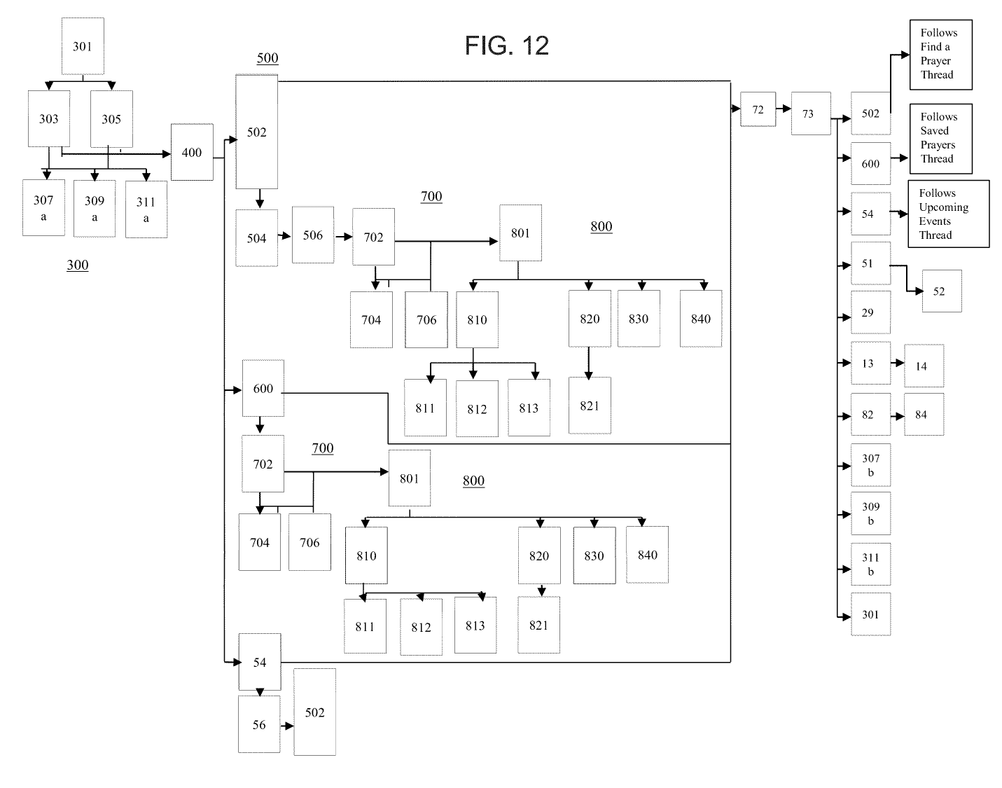

FIG. 12 is a view of a schematic diagram showing how a user may be enabled to navigate between different threads and other functions of a non-limiting embodiment of the present system, as described in FIGS. 3A-11B, using an interface. In FIG. 12, the various interfaces are assigned like reference numerals to the corresponding images in FIGS. 3A-11B. The functionality of these aspects of non-limiting embodiments of the present invention is described in greater detail above with regard to FIGS. 3A-11B.

In a non-limiting embodiment, a news feed may be provided in the application that displays prayers of the day (or week, for example) on the client device 105. In another embodiment, implementation of tracking features that provide person-to-person and/or geographic tracking features to track prayers shared by users. Users may also be provided with the ability to tag prayers to publicly associate them with certain individuals, organizations, or locations. The application may also include information, such as top prayers of the day, trending prayers, most shared prayers by category, or other lists feasible using tracking, all of which may be displayed on the client device 105. In one non-limiting embodiment, the user has the ability to create user groups within the application. The system may also include functionality to provide the users with daily or periodic notifications to use the application, which may be disabled by the user, if so desired.

In one non-limiting embodiment, the present system has the ability to function on a variety of software platforms. These platforms include, but are not limited to, Android, Windows, and iOS. The system may also include cross platform cloud functionality. In some embodiments, the application may operate as an integrated mobile application and website. Advertising may also be incorporated into the application in various user interfaces.

The system, in a further non-limiting embodiment, may also include a hierarchy of achievement awards that a user can earn. A user may be provided with a reward, such as greater access to the functionality of the present system. Alternatively or additionally, the user may receive virtual awards, such as a virtual trophy, which may be displayed to others upon completion of achievements. Some milestones that may trigger awards may include sharing prayers from each category, sharing prayers for so many consecutive days, providing feedback regarding a specified number of prayers, and like achievements. It will also be appreciated that other methods of including a hierarchy of achievement awards a user can earn may be provided.

In another non-limiting embodiment, the system includes pay features, for which the user must pay in order to utilize. For example, pay features may be based on monthly use limits. For instance, a user may only share a specified number of prayers each month without paying to upgrade the account. As another example, users can pay in order to enter or upload their own prayers. Users may have the option to purchase prayer packs by category of prayer or any other means of grouping (e.g., by religious denominations, popularity, etc.) after the user has exceeded the set limit of prayer sharing that comes with the initial download. Users can also purchase expanded customization options. For instance, by purchasing an upgrade, a user is allowed to access an expanded color palette for backgrounds, either through a given selection or a color picker. A user may also purchase an upgrade to access photo effects to use on images uploaded for backgrounds. Further, a user may pay for an upgrade, which provides the user with the ability to re-position text within the frame on a customized prayer. In one non-limiting embodiment, the pay features may be purchased as “in-app purchases.”

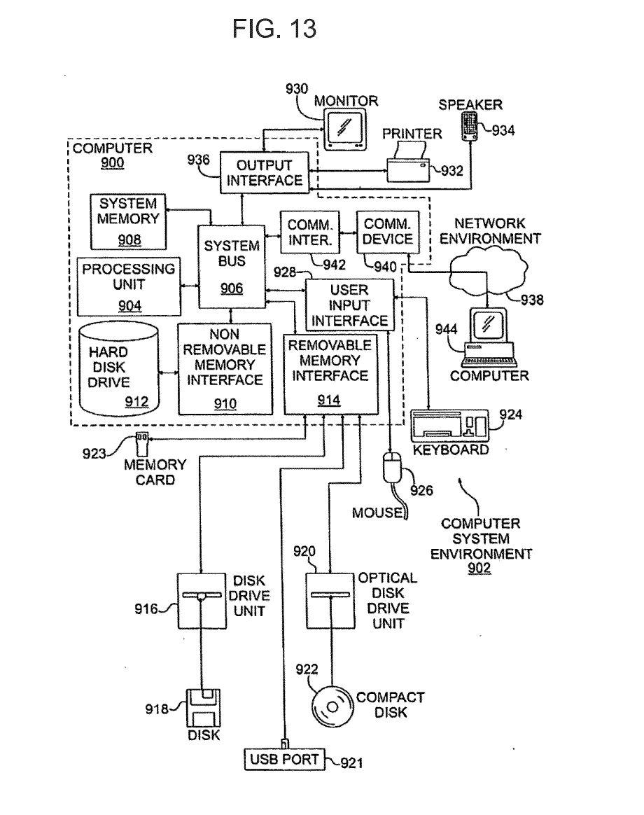

The present invention may be implemented on a variety of computing devices and systems, wherein these computing devices include the appropriate processing mechanisms and computer-readable media for storing and executing computer-readable instructions, such as programming instructions, code, and the like. As shown in FIG. 13, personal computers 900, 944, in a computing system environment 902 are provided. This computing system environment 902 may include, but is not limited to, at least one computer 900 having certain components for appropriate operation, execution of code, and creation and communication of data. For example, the computer 900 includes a processing unit 904 (typically referred to as a central processing unit or CPU) that serves to execute computer-based instructions received in the appropriate data form and format. Further, this processing unit 904 may be in the form of multiple processors executing code in series, in parallel, or in any other manner for appropriate implementation of the computer-based instructions.

In order to facilitate appropriate data communication and processing information between the various components of the computer 900, a system bus 906 is utilized. The system bus 906 may be any of several types of bus structures, including a memory bus or memory controller, a peripheral bus, or a local bus using any of a variety of bus architectures. In particular, the system bus 906 facilitates data and information communication between the various components (whether internal or external to the computer 900) through a variety of interfaces, as discussed hereinafter.

The computer 900 may include a variety of discrete computer-readable media components. For example, this computer-readable media may include any media that can be accessed by the computer 900, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 900. Further, this computer-readable media may include communications media, such as computer-readable instructions, data structures, program modules, or other data in other transport mechanisms and include any information delivery media, wired media (such as a wired network and a direct-wired connection), and wireless media. Computer-readable media may include all machine-readable media with the sole exception of transitory, propagating signals. Of course, combinations of any of the above should also be included within the scope of computer-readable media.

The computer 900 further includes a system memory 908 with computer storage media in the form of volatile and non-volatile memory, such as ROM and RAM. A basic input/output system (BIOS) with appropriate computer-based routines assists in transferring information between components within the computer 900 and is normally stored in ROM. The RAM portion of the system memory 908 typically contains data and program modules that are immediately accessible to or presently being operated on by processing unit 904, e.g., an operating system, application programming interfaces, application programs, program modules, program data, and other instruction-based computer-readable codes.

With continued reference to FIG. 13, the computer 900 may also include other removable or non-removable, volatile or non-volatile computer storage media products. For example, the computer 900 may include a non-removable memory interface 910 that communicates with and controls a hard disk drive 912, i.e., a non-removable, non-volatile magnetic medium; and a removable, non-volatile memory interface 914 that communicates with and controls a magnetic disk drive unit 916 (which reads from and writes to a removable, non-volatile magnetic disk 918), an optical disk drive unit 920 (which reads from and writes to a removable, non-volatile optical disk 922, such as a CD ROM), a Universal Serial Bus (USB) port 921 for use in connection with a removable memory card, etc. However, it is envisioned that other removable or non-removable, volatile or non-volatile computer storage media can be used in the exemplary computing system environment 900, including, but not limited to, magnetic tape cassettes, DVDs, digital video tape, solid state RAM, solid state ROM, etc. These various removable or non-removable, volatile or non-volatile magnetic media are in communication with the processing unit 904 and other components of the computer 900 via the system bus 906. The drives and their associated computer storage media discussed above and illustrated in FIG. 13 provide storage of operating systems, computer-readable instructions, application programs, data structures, program modules, program data, and other instruction-based computer-readable code for the computer 900 (whether duplicative or not of this information and data in the system memory 908).

A user may enter commands, information, and data into the computer 900 through certain attachable or operable input devices, such as a keyboard 924, a mouse 926, etc., via a user input interface 928. Of course, a variety of such input devices may be utilized, e.g., a microphone, a trackball, a joystick, a touchpad, a touch-interface, a scanner, etc., including any arrangement that facilitates the input of data, and information to the computer 900 from an outside source. As discussed, these and other input devices are often connected to the processing unit 904 through the user input interface 928 coupled to the system bus 906, but may be connected by other interface and bus structures, such as a parallel port, game port, or a universal serial bus (USB). Still further, data and information can be presented or provided to a user in an intelligible form or format through certain output devices, such as a monitor 930 (to visually display this information and data in electronic form), a printer 932 (to physically display this information and data in print form), a speaker 934 (to audibly present this information and data in audible form), etc. All of these devices are in communication with the computer 900 through an output interface 936 coupled to the system bus 906. It is envisioned that any such peripheral output devices be used to provide information and data to the user.

The computer 900 may operate in a network environment 938 through the use of a communications device 940, which is integral to the computer or remote therefrom. This communications device 940 is operable by and in communication to the other components of the computer 900 through a communications interface 942. Using such an arrangement, the computer 900 may connect with or otherwise communicate with one or more remote computers, such as a remote computer 944, which may be a personal computer, a server, a router, a network personal computer, a peer device, or other common network nodes, and typically includes many or all of the components described above in connection with the computer 900. Using appropriate communication devices 940, e.g., a modem, a network interface or adapter, etc., the computer 900 may operate within and communication through a local area network (LAN) and a wide area network (WAN), but may also include other networks, such as a virtual private network (VPN), an office network, an enterprise network, an intranet, the Internet, etc. It will be appreciated that the network connections shown are exemplary and other means of establishing a communications link between the computers 900, 944 may be used.

As used herein, the computer 900 includes or is operable to execute appropriate custom-designed or conventional software to perform and implement the processing steps of the method and system of the present invention, thereby, forming a specialized and particular computing system. Accordingly, the presently-invented method and system may include one or more computers 900 or similar computing devices having a computer-readable storage medium capable of storing computer-readable program code or instructions that cause the processing unit 902 to execute, configure, or otherwise implement the methods, processes, and transformational data manipulations discussed hereinafter in connection with the present invention. Still further, the computer 900 may be in the form of a smartphone, a tablet computer, a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A computer-implemented method for displaying at least one prayer on at least one client device including at least one processor, the method comprising:
receiving, at at least one server computer, a share request from a first client device, the share request comprising: (i) a selection of at least one prayer, and (ii) at least one customization option for the at least one prayer;
generating, with the at least one processor, a customized prayer based at least partially on the share request; and
communicating the customized prayer to at least one second client device.

2. The computer-implemented method of claim 1, wherein the at least one customization option comprises at least one of the following: a font color, a font style, a background color, a selection of a pre-recorded or computer-generated voice in which the prayer is to be verbalized on the at least one second client device, a language of the prayer, an addition, deletion, or replacement of a portion of the text of the prayer, a specific translation of the prayer, a selection of a version of the prayer associated with a particular religious denomination, or any combination thereof.

3. The computer-implemented method of claim 1, wherein the at least one prayer is selected from a prayer database comprising a plurality of prayers indexed by at least one of the following: religious denomination, keyword, appropriate occasion, popularity, average user rating, appropriate recipient, or any combination thereof, and wherein the plurality of prayers are displayed in a result set comprising at least one of the following: shortened versions, shortened titles, abbreviations of the prayers, or any combination thereof.

4. The computer-implemented method of claim 1, wherein the at least one prayer comprises a user-generated prayer, the method further comprising:
receiving the user-generated prayer at the at least one server computer; and
indexing the user-generated prayer in a prayer database in communication with at least the at least one second client device,
wherein the user-generated prayer is indexed by at least one of the following: religious denomination, keyword, appropriate occasion, popularity, average user rating, appropriate recipient, or any combination thereof, and wherein the indexing is either automatic or based at least partially on data provided by at least one user or administrator.

5. The computer-implemented method of claim 1, wherein the share request further comprises at least one supplemental dispatch, the supplemental dispatch comprising at least one of the following: a textual message, an image, a photograph, a virtual icon, an audio message, a video message, an indication of the geographic location of the first client device, a request to have a gift sent to a recipient, a monetary gift to a recipient, a virtual gift to a recipient, or any combination thereof, the method further comprising communicating data corresponding to the at least one supplemental dispatch to the at least one second client device.

6. The computer-implemented method of claim 1, further comprising providing the first client device with an electronic version of at least a portion of at least one religious text, wherein the at least one prayer comprises a selection from the at least one religious text.

7. The computer-implemented method of claim 1, wherein the customized prayer is communicated via at least one of the following: email, text message, a social media service, or any combination thereof.

8. The computer-implemented method of claim 1, further comprising:
identifying at least one temporal event; and
at a specified time associated with the at least one temporal event, causing the first client device to display an audio or visual notification that the at least one prayer should be sent, wherein the at least one temporal event is identified based at least partially on at least one of the following: data from an electronic calendar in communication with the first client device, data inputted by a user or administrator into the at least one client device or a management computer, or any combination thereof.

9. The computer-implemented method of claim 1, wherein a user of at least the first client device is required to establish an account with a host in order to place the share request, the method further comprising selectively enabling a user associated with the first client device to utilize only a portion of a selection of available customization options as determined at least partially based on at least one access parameter associated with the user's account.

10. The computer-implemented method of claim 9, wherein the at least one access parameter comprises at least one of the following: an amount of payment that has been rendered by the user for additional functionality, a number of categories from which the user has shared prayers, a number of unique prayers the user has shared in a specified time period, a number of total prayers the user has shared in a specified time period, an amount of time a user has been using a specified mobile application, or any combination thereof.

11. A system for displaying at least one prayer on at least one client device including at least one processor, the system comprising at least one server computer programmed or configured to:
receive a share request from at least a first client device, the share request comprising: (i) a selection of at least one prayer, and (ii) at least one customization option for the at least one prayer;
generate a customized prayer based at least partially based on the share request; and
communicate the customized prayer to at least one second client device.

12. The system of claim 11, wherein the at least one customization option comprises at least one of the following: a font color, a font style, a background color, a selection of a pre-recorded or computer-generated voice in which the prayer is to be verbalized on the at least one second client device, a language of the prayer, an addition, deletion, or replacement of a portion of the text of the prayer, a specific translation of the prayer, a selection of a version of the prayer associated with a particular religious denomination, or any combination thereof.

13. The system of claim 11, wherein the at least one prayer is selected from a prayer database comprising a plurality of prayers indexed by at least one of the following: religious denomination, keyword, appropriate occasion, popularity, average user rating, and appropriate recipient, and wherein the plurality of prayers are displayed in a result set comprising at least one of the following: shortened versions, shortened titles, abbreviations of the prayers, or any combination thereof.

14. The system of claim 11, wherein the at least one prayer comprises a user-generated prayer, wherein the at least one server computer is further configured or programmed to index the user-generated prayer in a prayer database in communication with at least the at least one second client device, wherein the user-generated prayer is indexed by at least one of the following: religious denomination, keyword, appropriate occasion, popularity, average user rating, appropriate recipient, or any combination thereof, and wherein the user-generated prayer is indexed either automatically or based at least partially on data provided by at least one user or administrator.

15. The system of claim 11, wherein the share request further comprises at least one supplemental dispatch, the supplemental dispatch comprising at least one of the following: a textual message, an image, a photograph, a virtual icon, an audio message, a video message, an indication of the geographic location of the first client device, a request to have a gift sent to a recipient, a monetary gift to a recipient, a virtual gift to a recipient, or any combination thereof, and wherein the at least one server computer is further configured or programmed to communicate data corresponding to the at least one supplemental dispatch to the at least a second client device.

16. The system of claim 11, wherein the first client device is provided with an electronic version of at least a portion of at least one religious text, and wherein the at least one prayer comprises a selection from the at least one religious text.

17. The system of claim 11, wherein the customized prayer is communicated via at least one of the following: an email, a text message, a social media service, or any combination thereof.

18. The system of claim 11, wherein the at least one server computer is further programmed or configured to:
identify at least one temporal event; and
at a specified time associated with the at least one temporal event, cause the first client device to display an audio or visual notification that the at least one prayer should be sent, wherein the at least one temporal event is identified based at least partially on at least one of the following: data from an electronic calendar in communication with the first client device, data inputted by a user or administrator into the at least one client device or a management computer, or any combination thereof.

19. The system of claim 11, wherein a user of at least the first client device is required to establish an account with a host in order to place a share request, and wherein the at least one server computer is further programmed or configured to selectively enable a user associated with the first client device to utilize only a portion of a selection of available customization options as determined at least partially based on at least one access parameter associated with the user's account.

20. The system of claim 19, wherein the at least one access parameter comprises at least one of the following: an amount of payment that has been rendered by the user for additional functionality, a number of categories from which the user has shared prayers, a number of unique prayers the user has shared in a specified time period, a number of total prayers the user has shared in a specified time period, an amount of time a user has been using a specified mobile application, or any combination thereof.

21. A non-transitory machine-readable medium comprising program instructions that, when executed by at least one client device including at least one processor, cause the at least one client device to:
communicate a share request to at least one server computer, the share request comprising: (i) a selection of at least one prayer, and (ii) at least one customization option for the at least one prayer;
generate a customized prayer based at least partially on the share request; and
cause the at least one server computer to communicate the customized prayer to at least one second client device, wherein the customized prayer is generated at least partially based on the share request.

22. The non-transitory machine-readable medium of claim 21, wherein the at least one customization option comprises at least one of the following: a font color, a font style, a background color, a selection of a pre-recorded or computer-generated voice in which the prayer is to be verbalized on the at least one second client device, a language of the prayer, an addition, deletion, or replacement of a portion of the text of the prayer, a specific translation of the prayer, a selection of a version of the prayer associated with a particular religious denomination, or any combination thereof.

23. The non-transitory machine-readable medium of claim 21, wherein the at least one prayer is selected from a prayer database comprising a plurality of prayers indexed by at least one of the following: religious denomination, keyword, appropriate occasion, popularity, average user rating, appropriate recipient, or any combination thereof, and wherein the plurality of prayers are displayed in a result set comprising at least one of the following: shortened versions, shortened titles, abbreviations of the prayers, or any combination thereof.

24. The non-transitory machine-readable medium of claim 21, wherein the at least one prayer comprises a user-generated prayer, the non-transitory machine-readable medium further comprising program instructions that, when executed by the at least one client device, cause the at least one client device to:
communicate the user-generated prayer to the at least one server computer; and
cause the at least one server computer to index the user-generated prayer in a prayer database in communication with at least the at least one second client device,
wherein the user-generated prayer is indexed by at least one of the following: religious denomination, keyword, appropriate occasion, popularity, average user rating, appropriate recipient, or any combination thereof, and wherein the user-generated prayer is indexed either automatically or based at least partially on data provided by at least one user or administrator.

25. The non-transitory machine-readable medium of claim 21, wherein the share request further comprises at least one supplemental dispatch, the supplemental dispatch comprising at least one of the following: a textual message, an image, a photograph, a virtual icon, an audio message, a video message, an indication of the geographic location of the first client device, a request to have a gift sent to a recipient, a monetary gift to a recipient, a virtual gift to a recipient, or any combination thereof,
wherein the non-transitory machine-readable medium further comprises program instructions that, when executed by the at least one client device, cause the at least one client device to cause the at least one server computer to communicate data corresponding to the at least one supplemental dispatch to the at least one second client device.

26. The non-transitory machine-readable medium of claim 21, wherein the first client device is in communication with an electronic version of at least a portion of at least one religious text, and wherein the at least one prayer comprises a selection from the at least one religious text.

27. The non-transitory machine-readable medium of claim 21, wherein the customized prayer is communicated via at least one of the following: an email, a text message, a social media service, or any combination thereof.

28. The non-transitory machine-readable medium of claim 21, further comprising program instructions that, when executed by the at least one client device, cause the at least one client device to:
identify at least one temporal event; and
at a specified time associated with the at least one temporal event, display an audio or visual notification that the at least one prayer should be sent, wherein the at least one temporal event is identified based at least partially on at least one of the following: data from an electronic calendar in communication with the first client device, data inputted by a user or administrator into the at least one client device or a management computer, or any combination thereof.

29. The non-transitory machine-readable medium of claim 21, wherein a user of at least the first client device is required to establish an account with a host in order to place the share request, and wherein the user is selectively enabled to utilize only a portion of a selection of available customization options as determined at least partially based on at least one access parameter associated with the user's account.

30. The non-transitory machine-readable medium of claim 29, wherein the at least one access parameter comprises at least one of the following: an amount of payment that has been rendered by the user for additional functionality, a number of categories from which the user has shared prayers, a number of unique prayers the user has shared in a specified time period, a number of total prayers the user has shared in a specified time period, an amount of time a user has been using a specified mobile application, or any combination thereof.
